(19) United States
(12) Patent Application Publication
(10) Pub. No.: US 2013/0335346 A1
(43) Pub. Date: Dec. 19, 2013

(54) PORTABLE ELECTRONIC APPARATUS WITH SENSING MECHANISM OF PHYSIOLOGICAL CHARACTERISTICS AND RELATED METHOD THEREOF

(71) Applicant: PIXART IMAGING INC., Hsin-Chu City (TW)

(72) Inventors: Hsin-Chia Chen, Hsin-Chu City (TW); Hui-Hsuan Chen, Hsin-Chu City (TW); Chia-Fu Ko, Hsin-Chu City (TW); Ming-Tsan Kao, Hsin-Chu City (TW)

(73) Assignee: PIXART IMAGING INC., Hsin-Chu City (TW)

(21) Appl. No.: 13/736,912

(22) Filed: Jan. 8, 2013

(30) Foreign Application Priority Data
Jun. 13, 2012 (TW) 101121085

(51) Int. Cl. G06F 3/041

(52) U.S. Cl. CPC G06F 3/041
USPC 345/173

(57) ABSTRACT

A method used for a portable electronic apparatus includes: providing a touch panel for receiving an input of a user; and, determining whether to perform a sensing operation upon an sensed object corresponding to the input of the user via the touch panel to generate a sensing result which is associated with physiological characteristics.

### BACKGROUND OF THE INVENTION

1. Field of the Invention

The disclosed embodiments of the present invention relate to a sensing mechanism of physiological characteristics, and more particularly, to a sensing mechanism of physiological characteristics that is employed in a portable electronic apparatus.

2. Description of the Prior Art

Modern people frequently use portable electronic apparatuses for an extremely long duration. Hence, physical fatigue happens easily. In addition, while the user is using a portable electronic apparatus, the body may be vulnerable to fatigue due to staying in a poorer environment for a long period of time. Generally speaking, when the body fatigues, the user may need to continue to operate the portable electronic apparatus for a short period of time although the user perceives the physical fatigue. As a result, the fatigue of the body accumulates. Eventually, the excessive use of the body results in over fatigue. Therefore, a mechanism which can sense the user's physiological characteristics or physiological state and also can timely notice or warn the user while the use is using a portable electronic apparatus is obviously important.

### SUMMARY OF THE INVENTION

Therefore, one of the objectives of the present invention is to provide a method for a portable electronic apparatus and related portable electronic apparatus thereof, which can sense user's physiological characteristics or physiological state and timely notice or warn the user.

According to a first aspect of the present invention, a method used for a portable electronic apparatus is disclosed. The method includes: providing a touch panel for receiving an input of a user; and determining whether to perform a sensing operation upon a sensed object corresponding to the input of the user via the touch panel to generate a sensing result, which is associated with physiological characteristics.

According to a second aspect of the present invention, a portable electronic apparatus is disclosed. The portable electronic apparatus includes a touch panel and a sensing circuit, wherein the touch panel is arranged for receiving an input of an user; and the sensing circuit is coupled to the touch panel, and arranged for determining whether to perform a sensing operation upon a sensed object corresponding to the input of the user via the touch panel to generate a sensing result, which is associated with physiological characteristics.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a block diagram illustrating a portable electronic apparatus according to a first embodiment of the present invention.

FIG. 1B is a diagram illustrating the position of each element in a mouse apparatus implemented using the portable electronic apparatus shown in FIG. 1A.

FIG. 2 is a block diagram illustrating a portable electronic apparatus according to a second embodiment of the present invention.

FIG. 3 is a diagram illustrating the operations of the portable electronic apparatus in FIG. 1A.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another apparatus, that connection may be through a direct electrical connection, or through an indirect electrical connection via other devices and connections.

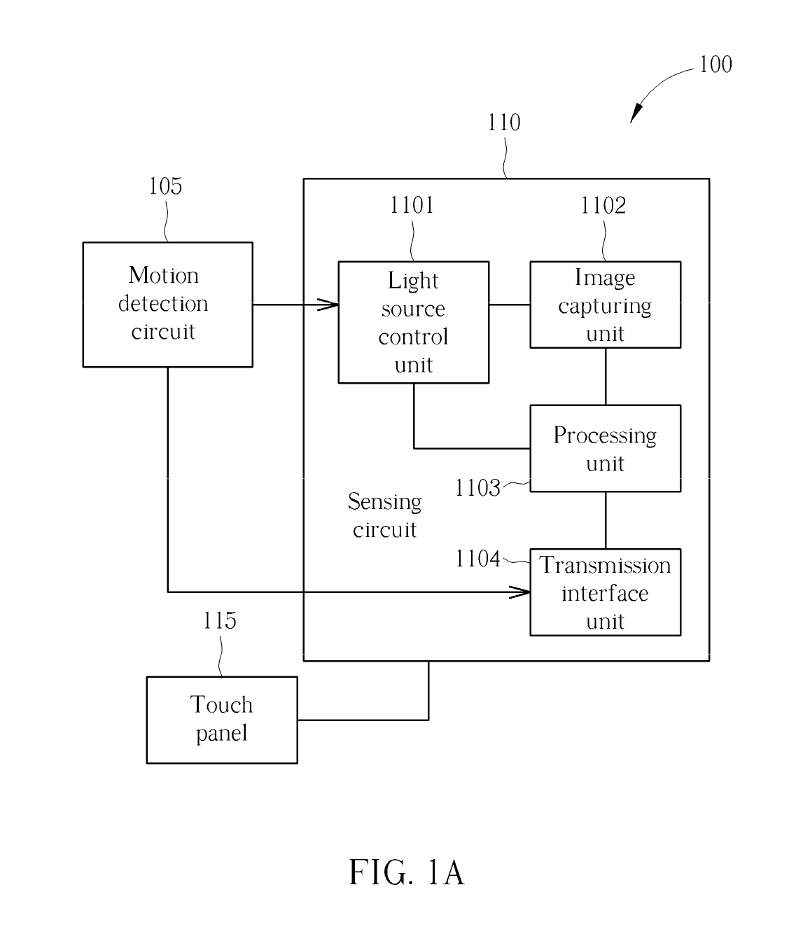

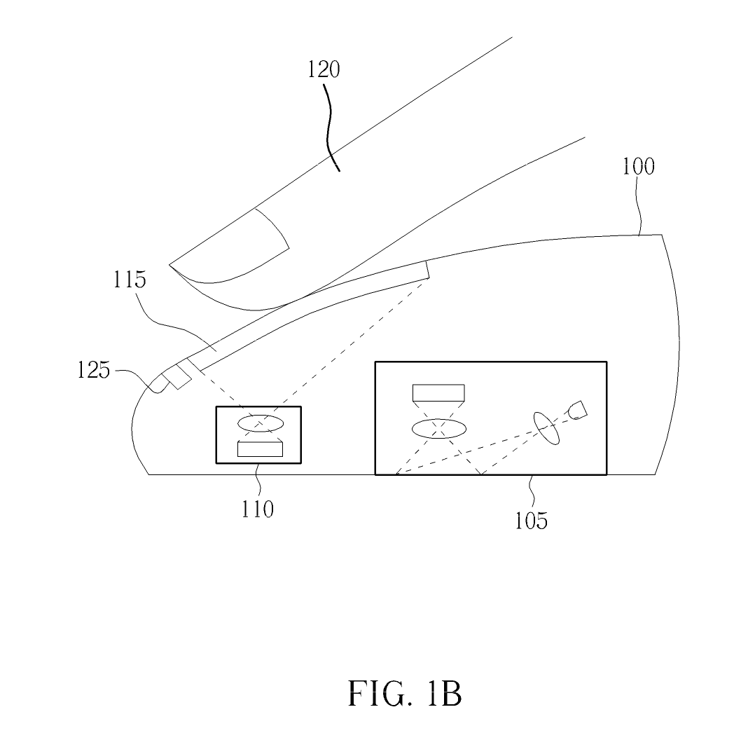

Please refer to FIG. 1A, which is a block diagram illustrating a portable electronic apparatus 100 according to a first embodiment of the present invention. As shown in FIG. 1A, the portable electronic apparatus 100 includes a motion detection circuit 105, a sensing circuit 110, and a touch panel 115. The sensing circuit 110 includes a light source control unit 1101, an image capturing unit 1102, a processing unit 1103, and a transmission interface unit 1104. In this embodiment, the portable electronic apparatus 100 has several functions and operations, such as the motion detection operation, the optical touch operation, and the optical sensing operation of the physiological characteristics. In a preferred embodiment, the portable electronic apparatus 100 is a pointing device, such as an optical pointing mouse or a laser mouse. In other words, the motion detection circuit 105 in the portable electronic apparatus 100 has the optical motion detection function, and can be utilized for performing the motion detection operation to thereby generate an optical motion detection result. The optical motion detection result may indicate whether the portable electronic apparatus 100 actually moves. If there is motion detected, the optical motion detection result may indicate the distance and direction of the detected motion. In addition, the touch panel 115 is used to receive a user input. Regarding the sensing circuit 110, it is coupled to the motion detection circuit 105 and the touch panel 115, and used for determining whether to perform the sensing operation of physiological characteristics upon a sensed object (e.g., a finger) corresponding to the user input through using the touch panel 115 and generate a sensing result correspondingly. The sensing result is a sensing result of physiological characteristics. The sensing circuit 110 may sense physical characteristics, such as user's physical characteristics including the heartbeat rate, the oxygen saturation, the blood velocity, etc. it should be noted that the physiological characteristics are for illustrative purposes only, and are not meant to be limitations of the present invention. In other embodiments, the sensing circuit 110 may be used to sense other physiological characteristic(s) such as the fingerprint.

In a preferred embodiment, the portable electronic apparatus 100 may be implemented, for example, as a pointing mouse device. While using the mouse, the user usually gently places the finger (e.g., a forefinger) upon the touch panel 115 of the mouse apparatus to have contact with the touch panel 115, and enables the corresponding functions through different gestures or other touch control manners. Please refer to FIG. 1B, which is a diagram illustrating the position of each element in a mouse apparatus implemented using the portable electronic apparatus 100 shown in FIG. 1A. As shown in FIG. 1B, the reference numeral 120 denotes a user's finger (i.e., the sensed object), the reference numeral 115 denotes a touch panel, the reference numeral 125 denotes an infrared light source used for emitting the optical sensing signal to the position of the sensed object, the reference numeral 110 denotes a sensing circuit, and the reference numeral 105 denotes a motion detection circuit. Therefore, when using the mouse apparatus, the user may gently place the finger 120 upon the touch panel 115 to be in contact with touch panel 115 with a considerable probability. In the embodiment of the present invention, the sensing circuit 110 performs sensing operation upon the sensed object (e.g., user's finger) in contact with the touch panel 115, and accordingly generates the sensing result of the physiological characteristics of the user. Therefore, regarding the user having long-term use of a mouse apparatus, the advantages/benefits of the embodiment of the present invention include sensing user's physiological characteristics or physiological state and timely noticing or warning the user each time there is any abnormal situation. Therefore, the user may be allowed to have the opportunity to have a complete rest under the long-term operation of the mouse apparatus.

In the first embodiment, in order to effectively enhance the sensing accuracy of the physiological characteristics, the sensing operation of the physiological characteristics, the motion detection operation, and the optical touch operating are respectively performed at different time points. That is, the sensing circuit 110 performs the sensing operation of the physiological characteristics only if there is no motion detected by the motion detection circuit 105 (the motion detection operation can be temporarily deactivated due to no motion detected, so it is equivalent to having no motion detection operation performed) and there is no touch operation performed by the user. This is because when the user drags the mouse apparatus and performs the operation to enable/disable the corresponding function via touching the touch panel with his/her fingers, the user's fingers are not stationarily placed on the touch panel 115. That is, the fingers have a greater opportunity to leave without contacting the surface of the touch panel 115. Hence, in the first embodiment of the present invention, the sensing circuit 110 performs the sensing operation of the physiological state when the user does not drag the mouse apparatus (there is no motion, actually) and does not perform the touch operation via gestures. Equivalently, when the portable electronic apparatus 100 substantially has no motion, it may be regarded as a first mode of the portable electronic apparatus 100; and when the portable electronic apparatus 100 substantially has motion, it may be regarded as a second mode of the portable electronic apparatus 100. When the portable electronic apparatus 100 operates in the first mode, the motion detection result indicates there is no motion substantially detected for the portable electronic apparatus 100. In accordance with the detection result, the sensing circuit 110 will determine whether to perform the sensing operation based on the control result corresponding to the user input. If the control result indicates that user's fingers are still, the sensing circuit 110 will determine to perform the sensing operation upon the fingers via the touch panel 115 for generating the sensing result associated with physiological characteristics. However, when the portable electronic apparatus 100 operates in the second mode, the motion detection result indicates that there is motion substantially detected for the portable electronic apparatus 100. In accordance with the detection result, the sensing circuit 110 will determine not to perform the sensing operation upon user's fingers. It should be noted that performing the motion detection operation, the optical touch operating, and the sensing operation of the physiological characteristics at different time points or in different modes is only one of the embodiments of the present invention. In other embodiments, the motion detection operation, the optical touch operation, and the sensing operation of physiological characteristics may be performed in the same mode or at the same time. Further, in other embodiments, the sequence of steps of determining whether to perform the sensing operation may be arranged to first determine whether the user is currently performing a touch operation according to the control result corresponding to the user's input, and then determine whether there is motion of the portable electronic apparatus 100 detected based on the motion detection result for determining whether to perform the sensing operation.

The sensing operation of the sensing circuit 110 is described in the following. The light source control unit 1101 is used to control, adjust, or generate the optical signal emitted by the infrared light source 125 shown in FIG. 1B. For example, the processing unit 1103 can output an intensity setting of the light source to the light source control unit 1101 such that the light source control unit 1101 can control the intensity of the optical signal generated by the infrared light source 125 during the sensing operation. When the ambient light is too bright or too dark, adjusting the optical signal can compensate the sensing deviation to a certain extent. Hence, the light source control unit 1101 refers to the adjusted intensity of the emission light source to control the light source 125 to emit an optical sensing signal to the sensed object (i.e., user's finger). In practice, the optical sensing signal emitted by the light source may be an infrared signal; however, this is not meant to be a limitation of the present invention. Next, the image capturing unit 1102 receives a reflected signal corresponding to the optical sensing signal, and captures the image of the finger. In practice, the reflected signal makes the image of the finger formed on the sensing region of the sensing component of the image capturing unit 1102, and thus the image capturing unit 1102 can generate and output multiple images of the sensed object at different time points. The processing unit 1103 is coupled to the image capturing unit 1102, and used to generate the sensing result by comparing multiple images of the sensed object (i.e., the current imaging and previous imaging on the sensing component). The sensing result can indicate user's physiological characteristics corresponding to the sensed object, such as heartbeat rate, oxygen concentration, and blood velocity.

In addition, the motion detection result generated by the motion detection circuit 105 is outputted to the transmission interface unit 1104, and the sensing result determined and generated by the processing unit 1103 may also be outputted to the transmission interface unit 1104. Therefore, the results of the aforementioned motion detection and sensing operations of physiological characteristics can be transmitted to other external electronic apparatuses via the transmission interface unit 1104 for other external electronic apparatuses' reference. Further, the transmission interface unit 1104 can also transmit the sensing result of physiological characteristics to a warning device (not shown in FIG. 1A) disposed on the motion detection apparatus 100. In this way, the warning device can be utilized to output an alert signal to inform the user of a message associated with physiological characteristics. For example, the warning device may be an audio device, while the warning signal may be a warning audio signal generated by the warning device to notify the user that his/her physiological characteristic (e.g., heartbeat rate, oxygen saturation, or blood velocity) reaches an abnormal level. The user will know that he/she overly uses the portable electronic apparatus in which the motion detection apparatus 100 is disposed. Hence, one of the advantages of the embodiment of the present invention is sensing user's physiological characteristics to inform the user of information of the excessive use of the optical mouse, such that the user has the opportunity for having a complete rest of the hands and temporarily stopping using the optical mouse.

Further, in order to simplify the computation and save the calculation time, in other embodiments, the sensing operation of the sensing circuit 110 may be configured to determine whether to perform the sensing operation of physiological characteristic only based on the motion detection result generated by the motion detection circuit 105 without referring to the control result corresponding to the user's input received by the touch panel 115. The benefit of such a design is that it can improve the overall system execution performance.

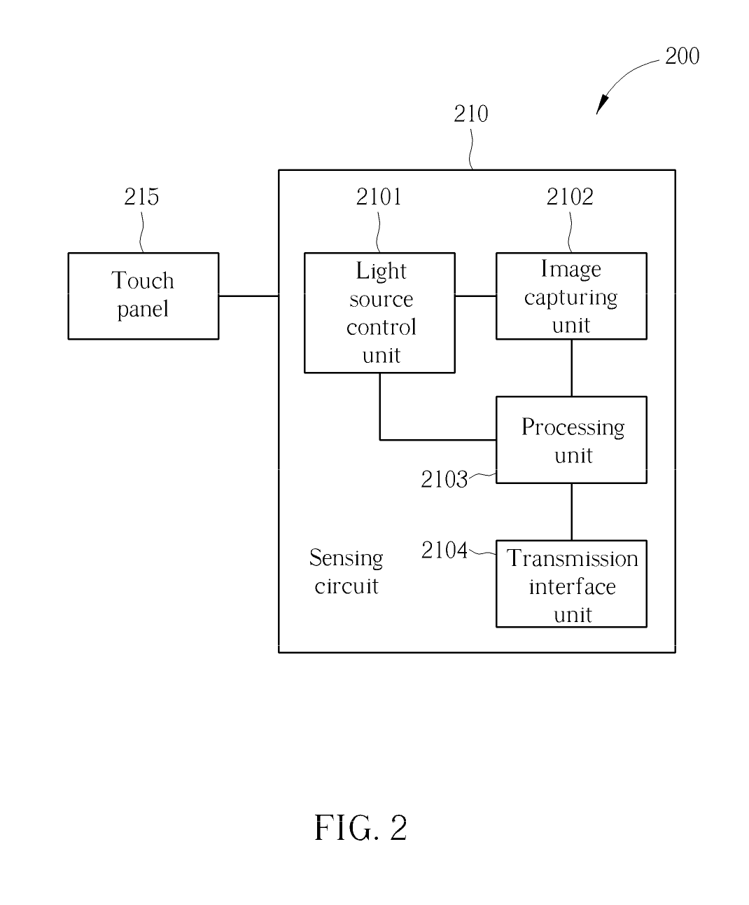

Please refer to FIG. 2, which is a block diagram illustrating a portable electronic apparatus 200 according to a second embodiment of the present invention. As shown in FIG. 2, the portable electronic apparatus 200 includes a sensing circuit 210 and a touch panel 215, wherein the sensing circuit 210 includes a light source control unit 2101, an image capturing unit 2102, a processing unit 2103, and a transmission interface unit 2104. It should be noted that, in the second embodiment, the portable electronic apparatus 200 does not include the motion detection circuit shown in FIG. 1A. Regarding the practical implementation, the portable electronic apparatus 200 can be implemented as a controller or a remote control having a touch panel. However, this is not meant to be a limitation of the present invention. Further, since there is no motion detection circuit implemented in the portable electronic apparatus 200, the sensing circuit 210 refers to a control result of the user's input received by the touch panel 215 to determine whether to perform the sensing operation of the physiological characteristics/state upon the corresponding sensed object (i.e., the user's finger). When the control result indicates that the finger corresponding to the user's input is substantially still, the sensing circuit 210 performs the sensing operation upon the finger via the touch panel 215; and when the control result indicates the finger corresponding to the user's input is not substantially still, the sensing circuit 210 does not perform the sensing operation upon the finger. In addition, it should be noted that the operations and functions of the light source control unit 2101, the image capturing unit 2102, the processing unit 2103, and the transmission interface unit 2104 in the sensing circuit 210 are the same as that of the light source control unit 1101, the image capturing unit 1102, the processing unit 1103, and the transmission interface unit 1104 in the sensing circuit 110 shown in FIG. 1A. Thus, the details are omitted here for brevity.

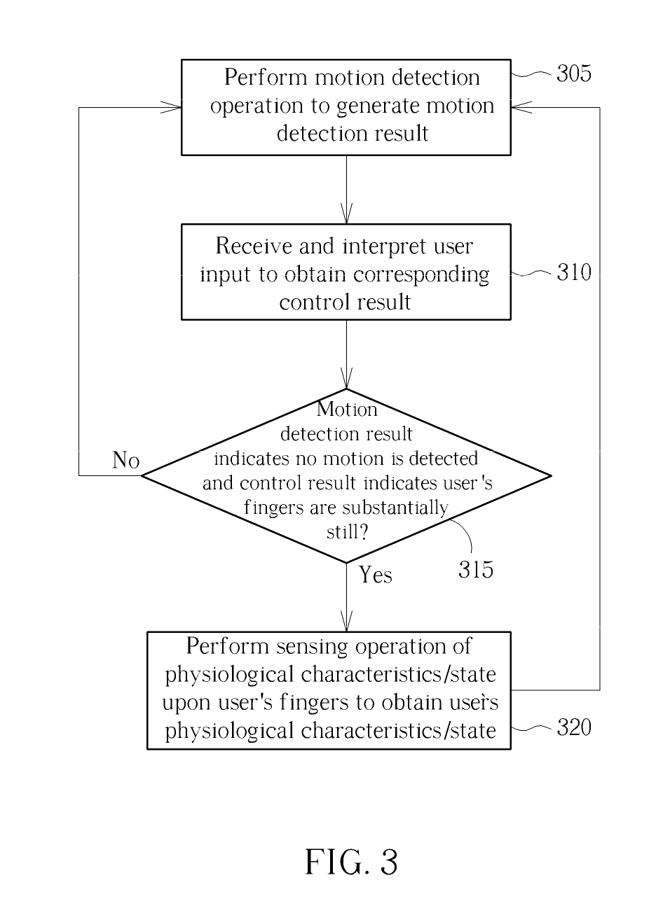

Please refer to FIG. 3 for better understanding of the spirit of the present invention. FIG. 3 is a diagram illustrating the operations of the portable electronic apparatus 100 shown in FIG. 1A. Provided that substantially the same result is achieved, the steps of the flowchart shown in FIG. 3 need not be in the exact order shown and need not be contiguous; that is, other steps can be intermediate. Besides, some of the steps shown in FIG. 3 can be omitted according to different embodiments or design requirements. The flow is described as follows:

Step 305: The motion detection circuit 105 performs the motion detection operation to generate a motion detection result;

Step 310: The touch panel 115 receives and interprets a user input to obtain the corresponding control result;

Step 315: Determine whether the motion detection result and the control result indicate that there is no motion detected and user's fingers are substantially still, respectively. If yes, proceed with step 320; otherwise, go back to step 305; and

Step 320: The sensing circuit 110 performs the sensing operation of physiological characteristics/state upon the user's fingers to obtain the user's physiological characteristics/state.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method used for a portable electronic apparatus, comprising:
providing a touch panel for receiving an input of an user; and
determining whether to perform a sensing operation upon a sensed object corresponding to the input of the user via the touch panel, to generate a sensing result which is associated with physiological characteristics.

2. The method of claim 1, wherein the step of determining whether to perform the sensing operation upon the sensed object corresponding to the input of the user via the touch panel comprises:
determining whether to perform the sensing operation upon the corresponding sensed object according to a control result of the input of the user received by the touch panel.

3. The method of claim 2, wherein:
when the control result indicates that the sensed object corresponding to the input of the user is substantially still, the touch panel is used for performing the sensing operation upon the sensed object; and
when the control result indicates that the sensed object corresponding to the input of the user is not substantially still, the touch panel is not used for performing the sensing operation upon the sensed object.

4. The method of claim 1, further comprising:
performing a motion detection operation to generate a motion detection result;
wherein the step of determining whether to perform the sensing operation upon the sensed object corresponding to the input of the user via the touch panel comprises:
determining whether to perform the sensing operation upon the sensed object corresponding to the input of the user via the touch panel according to the motion detection result.

5. The method of claim 4, wherein the step of determining whether to perform the sensing operation upon the sensed object corresponding to the input of the user via the touch panel comprises:
determining whether to perform the sensing operation upon the sensed object corresponding to the input of the user via the touch panel according to the motion detection result and a control result of the input of the user received by the touch panel.

6. The method of claim 4, wherein the step of determining whether to perform the sensing operation upon the sensed object corresponding to the input of the user via the touch panel according to the motion detection result comprises:
when the motion detection result indicates that the portable electronic apparatus operates in a first mode, performing the sensing operation upon the sensed object; and
when the motion detection result indicates that the portable electronic apparatus operates in a second mode, not performing the sensing operation upon the sensed object.

7. The method of claim 6, wherein the first mode indicates that the portable electronic apparatus substantially has no motion; and the second mode indicates that the portable electronic apparatus substantially has motion.

8. The method of claim 4, further comprising:
when the sensing operation is performed upon the sensed object, not performing the motion detection operation; and
when the sensing operation is not performed upon the sensed object, performing the motion detection operation.

9. The method of claim 4, wherein the sensed object contacts the touch panel, and the step of performing the sensing operation upon the sensed object via using the touch panel comprises:
adjusting intensity of an emission light source;
generating an optical sensing signal to the sensed object according to the adjusted intensity of the emission light source;
capturing at least one imaging of the sensed object according to a reflected signal corresponding to the optical sensing signal; and
generating the sensing result according to the at least one imaging.

10. The method of claim 1, wherein the physiological characteristics comprises heartbeat, oxygen saturation, or blood velocity.

11. A portable electronic apparatus, comprising:
a touch panel, arranged for receiving an input of an user; and
a sensing circuit, coupled to the touch panel, the sensing circuit arranged for determining whether to perform a sensing operation upon a sensed object corresponding to the input of the user via the touch panel to generate a sensing result, wherein the sensing result is associated with physiological characteristics.

12. The portable electronic apparatus of claim 11, wherein the sensing circuit determines whether to perform the sensing operation upon the corresponding sensed object according to a control result of the input of the user received by the touch panel.

13. The portable electronic apparatus of claim 12, wherein:
when the control result indicates that the sensed object corresponding to the input of the user is substantially still, the sensing circuit performs the sensing operation upon the sensed object via the touch panel; and when the control result indicates that the sensed object corresponding to the input of the user is not substantially still, the sensing circuit does not perform the sensing operation upon the sensed object via the touch panel.

14. The portable electronic apparatus of claim 11, further comprising:
a motion detection circuit, coupled to the sensing circuit, the motion detection circuit arranged for performing a motion detection operation to generate a motion detection result;
wherein the sensing circuit determines whether to perform the sensing operation upon the sensed object corresponding to the input of the user via the touch panel according to the motion detection result.

15. The portable electronic apparatus of claim 14, wherein the sensing circuit determines whether to perform the sensing operation upon the sensed object corresponding to the input of the user via the touch panel according to the motion detection result and a control result of the input of the user received by the touch panel.

16. The portable electronic apparatus of claim 14, wherein when the motion detection result indicates that the portable electronic apparatus operates in a first mode, the sensing circuit performs the sensing operation upon the sensed object; and when the motion detection result indicates that the portable electronic apparatus operates in a second mode, the sensing circuit does not perform the sensing operation upon the sensed object.

17. The portable electronic apparatus of claim 16, wherein the first mode indicates that the portable electronic apparatus substantially has no motion; and the second mode indicates that the portable electronic apparatus substantially has motion.

18. The portable electronic apparatus of claim 14, wherein when the sensing circuit performs the sensing operation upon the sensed object, the motion detection circuit does not perform the motion detection operation; and when the sensing circuit does not perform the sensing operation upon the sensed object, the motion detection circuit performs the motion detection operation.

19. The portable electronic apparatus of claim 14, wherein the sensed object contacts with the touch panel, and the sensing circuit adjusts intensity of an emission light source; generates an optical sensing signal to the sensed object according to the adjusted intensity of the emission light source; captures at least one imaging of the sensed object according to a reflected signal corresponding to the optical sensing signal; and generates the sensing result according to the at least one imaging.

20. The portable electronic apparatus of claim 11, wherein the physiological characteristics comprises heartbeat, oxygen saturation, or blood velocity.
